(19) United States
(12) Patent Application Publication
(10) Pub. No.: US 2025/0096894 A1
(43) Pub. Date: Mar. 20, 2025

(54) Reciprocity Based Estimation of Optical Channel Gain

(71) Applicant: Telefonaktiebolaget LM Ericsson (publ), Stockholm (SE)

(72) Inventors: Athanasios Stavridis, Malmö (SE); Rafael Puerta, Sundbyberg (SE); Ahmet Burak Ozyurt, Edinburgh (GB); Per-Erik Eriksson, Stockholm (SE)

(21) Appl. No.: 18/291,777

(22) PCT Filed: Oct. 15, 2021
(86) PCT No.: PCT/EP2021/078621

§ 371 Date: Jan. 24, 2024

(30) Foreign Application Priority Data
Jul. 29, 2021 (TR) 2021/012060

(51) Int. Cl. H04B 10/116; H04B 10/114; H04B 10/43

(52) U.S. Cl. CPC H04B 10/116; H04B 10/1143; H04B 10/43

(57) ABSTRACT

Using a light-emitting diode, LED, (211, 221) of the wireless communication device (210, 220) as a receiver, a wireless communication device (210, 220) receives an optical reference signal from an LED (211, 221) of a further wireless communication device. Based on the optical reference signal as received by the LED (211, 221), the wireless communication device (210, 220) estimates a first channel gain of an optical channel from the LED (211, 221) of the further wireless communication device (210, 220) to the LED (211, 221) of the wireless communication device (210, 220). Based on the estimated first channel gain, the wireless communication device (210, 220) estimates a second channel gain of an optical channel from the LED (211, 221) of the wireless communication device (210, 220) to the LED (211, 221) of the further wireless communication device (210, 220). Based on the estimated second channel gain, the wireless communication device (210, 220) controls transmission of outgoing optical wireless communication signals from the wireless communication device (210, 220) to the further wireless communication device (210, 220).

### TECHNICAL FIELD

The present invention relates to methods for controlling optical wireless communication and to corresponding devices, systems, and computer programs.

### BACKGROUND

Optical wireless communication, also denoted as light communication (LC), is expected to have potential to become a new means of indoor wireless communication. Such LC technologies may be based on visible light or infrared light. It is expected that an LC system can achieve a throughput of Gigabits per second. Typically LC technologies are based on communicating binary data using rapidly varying levels of light intensity. For example, one or multiple Light Emitting Diodes (LEDs) are provided in a transmitting device in order to modulate binary data in different levels of emitted light intensity. The levels of the emitted light intensity may be changed at rates that are not perceivable by the human eye. Thus, it is for example possible to incorporate LC in an illumination system, without affecting the quality of illumination. A receiver may detect the changes of the emitted light intensity, e.g., using Photo Detectors (PDs). In this way, the receiver is able to detect the transmitted binary data.

Due to the nature of optical transmitters and receivers, an LC system typically uses Intensity Modulation (IM) with Direct Detection (DD), in the following denoted as IM-DD, see for example “Wireless Infrared Communications” by J. M. Kahn and J. R. Barry, Proc. IEEE, vol. 85, no. 2, pp. 265-298, February 1997. This means that the transmitted/received signal is real and strictly positive, which in turn imposes certain constraints on the deployed communication techniques, both in single-carrier and multi-carrier transmission.

In wireless communication systems, performance can be improved by controlling wireless transmissions taking into account channel characteristics, e.g., in terms of Channel State Information (CSI). However, in existing LC technologies efficient estimation of channel characteristics may be difficult to implement, e.g., due to the rather directive nature of light communication, which causes strong dependency of channel characteristics on relative positioning of transmitter and receiver, and also due to the fact that LC transmitters are typically based on LEDs while receivers are based on PDs, i.e., use IM-DD.

Accordingly, there is a need for techniques which allow for efficiently and accurately controlling optical wireless communication.

### SUMMARY

According to an embodiment, a method of controlling wireless transmissions in a wireless communication network is provided. According to the method, using an LED of the wireless communication device as a receiver, a wireless communication device receives an optical reference signal from an LED of a further wireless communication device. Based on the optical reference signal as received by the LED, the wireless communication device estimates a first channel gain of an optical channel from the LED of the further wireless communication device to the LED of the wireless communication device. Based on the estimated first channel gain, the wireless communication device estimates a second channel gain of an optical channel from the LED of the wireless communication device to the LED of the further wireless communication device. Based on the estimated second channel gain, the wireless communication device controls transmission of outgoing optical wireless communication signals from the wireless communication device to the further wireless communication device.

According to a further embodiment, a wireless communication device is provided. The wireless device is configured to, using an LED of the wireless communication device as a receiver, receive an optical reference signal from an LED of a further wireless communication device. Further, the wireless device is configured to, based on the optical reference signal as received by the LED, estimate a first channel gain of an optical channel from the LED of the further wireless communication device to the LED of the wireless communication device. Further, the wireless device is configured to, based on the estimated first channel gain, estimate a second channel gain of an optical channel from the LED of the wireless communication device to the LED of the further wireless communication device. Further, the wireless device is configured to, based on the estimated second channel gain, control transmission of outgoing optical wireless communication signals from the wireless communication device to the further wireless communication device.

According to a further embodiment, a wireless communication device is provided. The wireless communication device comprises at least one processor and a memory. The memory contains instructions executable by said at least one processor, whereby the wireless communication device is operative to, using an LED of the wireless communication device as a receiver, receive an optical reference signal from an LED of a further wireless communication device.

Further, the memory contains instructions executable by said at least one processor, whereby the wireless communication device is operative to, based on the optical reference signal as received by the LED, estimate a first channel gain of an optical channel from the LED of the further wireless communication device to the LED of the wireless communication device. Further, the memory contains instructions executable by said at least one processor, whereby the wireless communication device is operative to, based on the estimated first channel gain, estimate a second channel gain of an optical channel from the LED of the wireless communication device to the LED of the further wireless communication device. Further, the memory contains instructions executable by said at least one processor, whereby the wireless communication device is operative to, based on the estimated second channel gain, control transmission of outgoing optical wireless communication signals from the wireless communication device to the further wireless communication device.

According to a further embodiment, a computer program or computer program product is provided, e.g., in the form of a non-transitory storage medium, which comprises program code to be executed by at least one processor of a wireless communication device is provided. Execution of the program code causes the wireless communication device to, using an LED of the wireless communication device as a receiver, receive an optical reference signal from an LED of a further wireless communication device. Further, execution of the program code causes the wireless communication device to, based on the optical reference signal as received by the LED, estimate a first channel gain of an optical channel from the LED of the further wireless communication device to the LED of the wireless communication device. Further, execution of the program code causes the wireless communication device to, based on the estimated first channel gain, estimate a second channel gain of an optical channel from the LED of the wireless communication device to the LED of the further wireless communication device. Further, execution of the program code causes the wireless communication device to, based on the estimated second channel gain, control transmission of outgoing optical wireless communication signals from the wireless communication device to the further wireless communication device.

Details of such embodiments and further embodiments will be apparent from the following detailed description of embodiments.

### BRIEF DESCRIPTION OF THE DRAWINGS

FIG. 1 schematically illustrates an example of a scenario where optical wireless communication is controlled according to an embodiment.

FIG. 2 shows a block diagram for schematically illustrating optical channels as considered according to an embodiment.

FIG. 3 shows an example of processes for controlling half-duplex communication according to an embodiment.

FIG. 4 shows an example of processes for controlling full-duplex communication according to an embodiment.

FIG. 5 shows a flowchart for illustrating a procedure for estimating an LED-PD channel according to a further embodiment.

FIG. 6 shows a further example of processes for controlling full-duplex communication according to an embodiment.

FIG. 7 shows a flowchart for schematically illustrating a method according to an embodiment.

FIG. 8 shows a block diagram for schematically illustrating functionalities of a wireless communication device according to an embodiment.

FIG. 9 schematically illustrates structures of a wireless communication device according to an embodiment.

### DETAILED DESCRIPTION OF EMBODIMENTS

In the following, concepts in accordance with exemplary embodiments of the invention will be explained in more detail and with reference to the accompanying drawings. The illustrated embodiments relate to controlling of optical wireless communication (OWC), e.g., based on an LC technology utilizing light in the visible and/or infrared spectrum.

The illustrated concepts involve that an LED of a wireless communication device is used as a transmitter for OWC signals. At least for channel estimation purposes, the LED is further used as a receiver. In particular, the LED may be used to receive an optical reference signal from an LED of a further wireless communication device. Based on the optical reference signal as received by the LED, the wireless communication device estimates a first channel gain of an optical channel from the LED of the further wireless communication device to the LED of the wireless communication device. From the estimated first channel gain, and based on a channel reciprocity assumption, the wireless communication device estimates a second channel gain of an optical channel from the LED of the wireless communication device to the LED of the further wireless communication device. Further, the wireless communication device may use the first channel gain as a basis for estimating a channel gain from the LED of the wireless communication device to a PD of the further wireless communication device. These estimations may further be based on knowledge of the optical components used in the wireless communication devices, e.g., information on characteristics of the utilized LED(s) or PD(s). Based on the second channel gain, the wireless communication device controls transmission of outgoing OWC signals from the wireless communication device to the further wireless communication device. These outgoing OWC signals may include OWC signals transmitted from the LED of the wireless communication device to the LED of the further wireless communication device. Further, these outgoing OWC signals may include OWC signals transmitted from the LED of the wireless communication device to a PD of the further wireless communication device.

The illustrated concepts may thus be used to enable reciprocity-based OWC. When using the same LED as a transmitter and a receiver, the reciprocity-based OWC may be in a half-duplex (HD) mode, thereby taking into account that while the LED transmits an outgoing OWC signal, it cannot act as a receiver. When using one or more additional PDs as receiver, the reciprocity-based OWC can also be in a full-duplex (FD) mode. For FD reciprocity-based OWC, the LED can transmit outgoing OWC signals while the PD(s) receive incoming OWC signals, and utilization of the LED as a receiver may be limited to a channel estimation phase. As compared to conventional OWC systems using an LED as a transmitter and a PD as a receiver, utilization of the LED as a receiver for channel estimation, reciprocity-based OWC can be enabled in an efficient manner. In particular, it becomes possible to consider the fact that the optical channel from the LED of the wireless communication device to the PD of the further wireless communication device may differ from the optical channel from the LED of the further wireless communication device to the PD of the wireless communication device, e.g., due to the specific arrangement and characteristics of the LEDs and PDs on the different wireless communication devices.

Utilization of the LED as a receiver of the incoming optical signals, in particular for the optical reference signal, may be based on detection of discharging characteristic the LED: While the LED is not transmitting light and is charged in reverse bias, an inherent capacitance discharges at a rate which depends on intensity of light impinging onto the LED. Here, higher intensity of light results in a faster discharging rate. These principles are for example explained in “LED as Transmitter and Receiver of Light: A Simple Tool to Demonstration Photoelectric Effect” by G. Schirripa Spagnolo, F. Leccese, and M. Leccisi, Crystals, vol. 9, no. 10, pp. 1-17 (October 2019). Accordingly, in the illustrated concepts an intensity modulation of the incoming OWC signals can be detected based on the discharging rate of the LED(s). The operation of the LED(s) as both transmitter and receiver may thus be based on intensity-modulation (IM) and direct-detection (DD), in the following referred to as IM-DD operation.

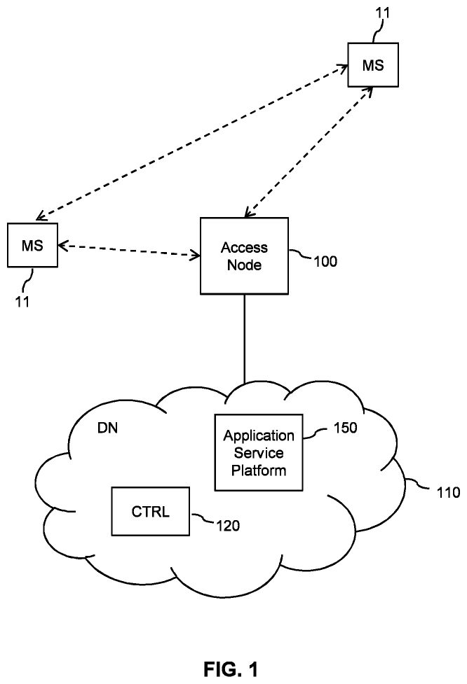

FIG. 1 schematically illustrates an example of a scenario where OWC is controlled in accordance with the illustrated concepts. Specifically, FIG. 1 illustrates a wireless communication network environment which is, at least in part, based on utilization of OWC. It is noted that the wireless communication network could additionally also support one or more other wireless communication technologies, e.g., a Wireless Local Area Network (WLAN) technology and/or a cellular communication technology as for example specified by 3GPP (3^{rd} Generation Partnership Project). In the example of FIG. 1, the wireless communication network includes an access node 100 and a number of mobile stations (MSs) 11. As illustrated by broken arrows, each MS 11 may use OWC signals to connect to the access node 100. Further, it is also possible that two MSs 11 use OWC signals to connect directly to each other. The OWC signals may thus be used to establish one or more OWC links. The OWC may be bi-directional. Accordingly, each MS 11 and the access node 100 may both transmit outgoing OWC signals and receive incoming wireless communication signals. OWC signals transmitted from the access node 100 to one of the MSs 11 may also be referred to as downlink (DL) OWC signals. OWC signals transmitted from one of the MSs 11 to the access node 100 may also be referred to as downlink (UL) OWC signals. OWC signals transmitted between two MSs 11 may also be referred to as device-to-device (D2D) OWC signals.

Based on the DL and UL OWC signals, the access node 100 may provide data connectivity of the MSs 11 among each other and/or with respect to a data network (DN) 110. In this way, the access node 100 may also provide data connectivity of a given MS 11 other entities, e.g., to one or more servers, service providers, data sources, data sinks, user terminals, host computers, or the like. Accordingly, an OWC link established between a given MS 11 and the access node 100 may be used for providing various kinds of data services to the MS 11, e.g., a service related to industrial machine control. Such services may be based on applications which are executed on the MS 11 and/or on a device linked to the MS 11. By way of example, FIG. 1 illustrates an application service platform 150 provided in the DN 110. The application(s) executed on the MS 11 and/or on one or more other devices linked to the MS 11 may use the respective OWC link established by the MS 11 for data communication with one or more other MSs 11 and/or the application service platform 150, thereby enabling utilization of the corresponding service(s) at the MS 11. As further illustrated, the DN 110 includes a control node 120, which may be used for controlling and otherwise coordinating operation of the access node 100 and MSs 11.

It is noted that the wireless communication network may also include additional access nodes in order to enhance wireless coverage of the wireless communication network. Each of such access nodes may operate as explained for the access node 100 to provide data connectivity to one or more connected MSs.

As mentioned above, the OWC between a first and a second wireless communication device is based on an LED in each wireless communication device. However, it would also be possible that each wireless communication is provided with multiple LEDs, each of which can be used as a transmitter of outgoing OWC signals and, for channel estimation, as a receiver of optical reference signals. Further, each LED can be used as a receiver of incoming OWC signals. Still further, each wireless communication device may be provided with one or more PDs, which can also be used as a receiver of incoming OWC signals,

As explained in “Wireless Infrared Communications” by J. M. Kahn and J. R. Barry, Proc. IEEE, vol. 85, no. 2, pp. 265-298, February 1997, assuming a point-to-point LC system with Nₜ transmitting LEDs and Nᵣ receiving PDs, the optical channel, in time (t) domain, between the i-th PD, i=1, . . . , Nᵣ^{LC}, and the j-th LED, j=1, . . . , Nₜ^{LC} can be described as:

$${h}_{i , j}^{LC} ( t ) = {h}_{i , j}^{LOS} + {h}_{i , j}^{NLOS} ( t ) , \qquad ( 1 )$$

where h_{i,j}^{LOS} represents a Line-of-Sight (LoS) component and h_{i,j}^{NLOS} (t) represents a diffuse component. The LoS component h_{i,j}^{LOS} may also be referred to as Direct Current (DC) component. The LoS component h_{i,j}^{LOS} can be assumed to be time independent. The diffuse component h_{i,j}^{NLOS} (t) is the aggregate result of multiple light Non-Light-of-Sight (NLoS) reflections from the surrounding surfaces. The LoS component h_{i,j}^{NLOS} represents an LoS optical channel gain, which can be represented as:

$${h}_{i , j}^{LOS} = \{ \begin{matrix}( \frac{( k - 1 )}{2 π {d}_{i , j}^{2}} {cos}^{k} ( {ϕ}_{i , j} ) cos ( {ψ}_{i , j} ) , & 0 \leq {ψ}_{i , j} \leq {Ψ}_{\frac{1}{2}} \\ 0 , & {ψ}_{i , j} \geq {Ψ}_{\frac{1}{2} ,}\end{matrix} , \qquad ( 2 )$$

per area unit of PD surface. Here, k is the Lambertian factor which denotes a directionality order. The Lambertian factor k is given as:

$$k = - \frac{ln ( 2 )}{ln ( cos ( {Φ}_{\frac{1}{2}} ) )} , \qquad ( 3 )$$

with,

$${Φ}_{\frac{1}{2}}$$

being the transmitter semi-angle and d is the distance between the i-th PD and the j-th LED. The angles ϕ_{i,j} and ψ_{i,j} denote the angle of emission of the j-th LED to the i-th PD with respect to the transmitter plane and the angle of incidence of the light at the i-th PD from the j-th LED with respect to the orthonormal vector of the receiver plane of the i-th PD, respectively. The Field of View (FOV) semi-angel of each PD is denoted as Ψ_{1/2}. Given that the LEDs and PDs are placed in a three-dimensional space, their spatial positions can be described by their Cartesian coordinates. Thus, the angle ϕ_{i,j}, and ψ_{i,j} can be computed as:

$${ϕ}_{i , j} = arccos ( \frac{dot ( {o}_{t}^{j} , {p}_{r}^{i} - {p}_{t}^{j} )}{{d}_{i , j}} ) \qquad ( 4 )$$

$${ψ}_{i , j} = arccos ( \frac{dot ( {o}_{r}^{i} , {p}_{t}^{j} - {p}_{r}^{i} )}{{d}_{i , j}} ) . \qquad ( 5 )$$

In (5) and (4), dot(x,y)=x^{T}y, represents the inner product between the vectors x and y. Also, pₜ^{j} and pᵣⁱ are 3×1 vectors which represent the Cartesian coordinates of the j-th LED, j=1, . . . , Nₜ^{LC}, and, i-th PD, i=1, . . . , Nᵣ^{LC}, respectively. The orientation of the j-th LED, j=1, . . . , Nₜ, is given from the 3×1 orthonormal vector, oₜ^{j}, which is vertical to the plane of the LED. Similarly, the orthonormal vector, oᵣⁱ, which is vertical to the plane of the i-th PD, represents the orientation of the i-th PD. Finally, the distance, d_{i,j}, between the i-th PD and the j-th LED can be computed as, d_{i,j}=∥pᵣⁱ−pₜ^{j}∥₂. Even though the optical bandwidth is large, LC communication is bandwidth limited due to the frequency selective nature of the off-the-shelf LEDs. In more detail, an off-the-shelf LED behaves like a low-pass filter with a frequency response H_{i,j}^{LC}(f). Thus, the actual optical channel can be expressed as, H_{i,j}^{LC}(t,f)=rᵢAᵢ H_{LED} (f) h_{i,j}^{LOS}+h_{i,j}^{NLOS}(t)] where, h_{i,j}^{NLOS}(t)=Σₖ₌₁^{+∞}h_{i,j}^{k}(t). Here, rᵢ and Aᵢ represent the responsivity and area of the i-th PD, respectively. In addition, h_{i,j}^{k}(t), represents the light that propagates through the k-th path. Note, that the previous modeling takes into account the diffuse nature of the optical channel, e.g., due to diffuse reflections. Also, it is noted that the quantity h_{i,j}^{k}(t) solely depends on the geometry of the optical transceiver when it does not have a zero value for a given space. Given that the LoS component of an optical channel includes 95% of the energy collected by the PDs, it can be assumed that:

$${H}_{i , j}^{LC} ( t , f ) \approx {r}_{i} {A}_{i} {H}_{LED} ( f ) {h}_{i , j}^{LOS} . \qquad ( 6 )$$

Therefore, the photocurrent produced by the i-th receiving PDs due to the transmission of the j-th LED can be represented as

$${y}_{i} = {H}_{i , j}^{LC} ( t , f ) * x ( t , f ) + w ( t , f ) , \qquad ( 7 )$$

where, “*” represents a linear convolution operation, x(t,f) is the transmitted optical signal and w(t,f) is the sum of Gaussian and ambient noise.

When using LEDs as receivers, the above explanations for the optical channel and corresponding received optical signal made for the PDs also apply to each LED acting as a receiver.

As mentioned above, the illustrated concepts aim at efficiently enabling reciprocity-based OWC. For this purpose, the illustrated concepts specifically take into account that in bi-directional OWC, the receiver of incoming OWC signals, e.g., a PD, may be physically separated from an LED used a transmitter of outgoing OWC signals, and that this may be the case in both communicating ends. Such physical separation may amount up to several centimeters. Accordingly, if the transmitter of incoming OWC signals and the receiver of outgoing OWC signals are physically separated, it may depend on the specific geometry of the transmitters and receivers in the OWC system and/or on other hardware characteristics whether channel reciprocity of the optical channels can be assumed. In the illustrated concepts, this is addressed by utilizing the LED also as a receiver for channel estimation purposes, and in some cases also as a receiver for incoming OWC signals.

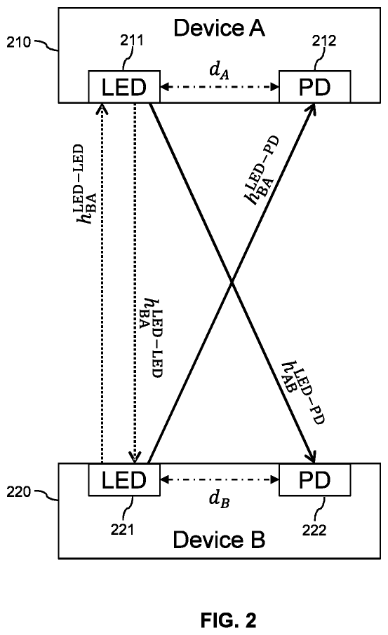

For explanation of the illustrated concepts, FIG. 2 schematically illustrates an OWC system which may be used for reciprocity-based OWC in accordance with the illustrated concepts. In particular, FIG. 2 illustrates a first wireless communication device 210, denoted as “Device A”, and a second wireless communication device 220, denoted as “Device B”, which can engage in bi-directional reciprocity-based OWC. The first wireless communication device 210 is provided with an LED 211 and with a PD 212. A distance between the LED 211 and the PD 212 is denoted by d_{A}. The LED 211 can act as a transmitter of outgoing OWC signals, and the PD 212 can act as a receiver of incoming OWC signals. Further, the LED can also be used as a receiver or optical signals, which can include optical reference signals or, in some cases, incoming OWC signals. The second wireless communication device 220 is provided with an LED 221 and with a PD 222. A distance between the LED 221 and the PD 222 is denoted by d_{B}. The LED 221 can act as a transmitter of outgoing OWC signals, and the PD 222 can act as a receiver of incoming OWC signals. Further, the LED can also be used as a receiver or optical signals, which can include optical reference signals or, in some cases, incoming OWC signals.

Accordingly, the following optical channels are available in the OWC system of FIG. 2: an LED-PD channel, represented by channel gain h_{AB}^{LED-PD}, from the LED 211 to the PD 222, an LED-LED channel, represented by channel gain h_{AB}^{LED-LED}, from the LED 211 to the LED 221, an LED-PD channel, represented by channel gain h_{BA}^{LED-PD}, from the LED 221 to the PD 212, and an LED-LED channel, represented by channel gain h_{BA}^{LED-LED}, from the LED 221 to the LED 211. The first wireless communication device 210 can send outgoing OWC signals via the LED-PD channel h_{AB}^{LED-PD} and/or the LED-LED channel h_{BA}^{LED-LED} to the second wireless communication device 220. The second wireless communication device 220 can send outgoing OWC signals via the LED-PD channel h_{BA}^{LED-PD} and/or the LED-LED channel h_{BA}^{LED-LED} to the first wireless communication device 210. Further, each of these optical channels can also be used for transmission of optical reference signals.

It is noted that the actual geometrical setup may differ from the illustration of FIG. 2. Further, it is noted that the channel gains h_{AB}^{LED-PD}, h_{BA}^{LED-PD}, h_{AB}^{LED-LED}, and h_{BA}^{LED-LED} do not include the influence of the involved transmitting LEDs.

In the following, it is described in more detail how the utilization of the LED 211, 221 as a receiver of optical signals can be used for channel estimation for reciprocity-based OWC between the wireless communication devices 210, 220. First, it will be explained how the second wireless communication device 220 can estimate the LED-LED channel gain h_{BA}^{LED-LED} from the second wireless communication device 220 to the first wireless communication device 210, using optical signals propagated on the reverse LED-LED channel gain h_{BA}^{LED-LED}. The estimated LED-LED channel gain h_{BA}^{LED-LED} can then be used for closed-loop reciprocity-based OWC from the first wireless communication device 210 to the second wireless communication device 220. It is however noted that the same principles can be applied by the first wireless communication device 210 for estimating the LED-LED channel h_{AB}^{LED-LED} from the first wireless communication device 210 to the first wireless communication device 220, which can then be used for closed-loop reciprocity-based OWC from the second wireless communication device 220 to the first wireless communication device 210. An example of such close-loop OWC is closed-loop digitally pre-coded OWC, where the digital precoding depends on the estimated optical channel. However, it is noted that other types of channel-estimation dependent OWC could be used as well, such as bit-loading and power adaptation.

From the above explanations, it can be seen that the optical channel is determined by a non-flat frequency response of the transmitting LED, denoted by H_{LED} (f), and the frequency independent actual optical channel propagation, h_{i,j}^{LOS}+h_{i,j}^{NLOS}(t), which corresponds to a sum of the LoS and NLoS components. As mentioned in connection with relation (6), it can be assumed that the NLoS component is negligible, i.e., h_{i,j}^{LOS}+h_{i,j}^{NLOS}(t)≈h_{i,j}^{LOS}. Further, the frequency response of the transmitting LED is typically known characteristic which is determined by design of the LED and can be measured in advance, e.g., for a series of LEDs of the same design. Accordingly, estimation of the frequency independent LoS component, which depends on the geometrical setup of transmitter and receiver, may be sufficient for the estimation of the actual optical channel.

When now assuming that, while not transmitting, the LED 221 of the second wireless communication device 220 receives an optical signal reference signal s from the LED 211 of the first wireless communication device 210, the optical reference signal s can be detected by the speed of discharging of the LED 221, which in turn can be detected as an electrical signal y_{electrical}^{B}. Here, higher level of optical power results in faster discharge and thus higher value of the electrical signal y_{electrical}^{B}. Accordingly, in a given sample period, there is a one-to-one correspondence between the received optical power y_{optical}^{LED}=H_{A}(f)h_{AB}^{LED}s and the electrical signal y_{electrical}^{B}. Mathematically, this can be expressed as:

$${y}_{electrical}^{B} = g ( {m}_{B} {H}_{A} ( f ) {h}_{AB}^{LED - LED} s ) + w , \qquad ( 8 )$$

where g(.) is a monotonic function which represents the depiction of the optical power received by the LED 221 to the electrical signal y_{electrical}^{B}, and H_{A}(f) is the frequency response of the transmitting LED 211. The exact form of g(.) depends on the specific design of the LED 221 and its associated circuitry used to produce the electrical signal y_{electrical}^{B}. The parameter m_{B} represents a multiplicative factor, reflecting for example the responsivity of reception and/or reception area of the LED 221. Furthermore, w represents random noise or some other type of disturbance during the conversion of the received optical power to the corresponding electrical signal y_{electrical}^{B}. Here, it is noted that because g(.) is monotonic, w constitutes an additive contribution. Assuming that w can be considered as a random variable, its statistical description, e.g., in terms of its Probability Density Function (PDF), depends on the specific electro-optical design of the LED 221 and its associated circuitry.

Consequently, assuming that the optical reference signal s and the frequency response of the LED 211, H_{A}(f), an estimate ĥ_{AB}^{LED-LED} of the actual optical channel gain h_{AB}^{LED-LED} can be derived from the sample of y_{electrical}^{B}. For this purpose, various types of estimator known from estimation theory can be used, such as a Maximum Likelihood (ML) or a Maximum A-Posteriori (MAP) estimator. Note that the influence of s and H_{A}(f), which are known contributions, can be removed by simple divisions.

The obtained estimate of the channel gain ĥ_{AB}^{LED-LED} can then be used to estimate an angle of emission, denoted by ϕ_{A}, of the LED 211 along with an LED-LED distance, denoted by d_{AB}, between the LED 211 and the LED 221. An angle of incidence of the LED 221 may be available from an internal sensor of the second wireless communication device 220. This information may be used by the second wireless communication device 220 to produce an estimate ĥ_{BA}^{LED-LED} of the channel gain of the LED-LED channel h_{AB}^{LED-LED} from the LED 221 to the LED 211, using for example a square error criterion and the assuming a channel representation in accordance with relation (6). As mentioned above, based on an optical reference signal s transmitted by the LED 221 and received by the LED 211, the first wireless communication device 210 can apply a corresponding procedure to produce an estimate ĥ_{AB}^{LED-LED} of the channel gain of the LED-LED channel h_{AB}^{LED-LED} from the LED 211 to the LED 221. Based on such estimated channel gains, bi-directional reciprocity-based HD OWC on the LED-LED channels between the first wireless communication device 210 and the second wireless communication device 220.

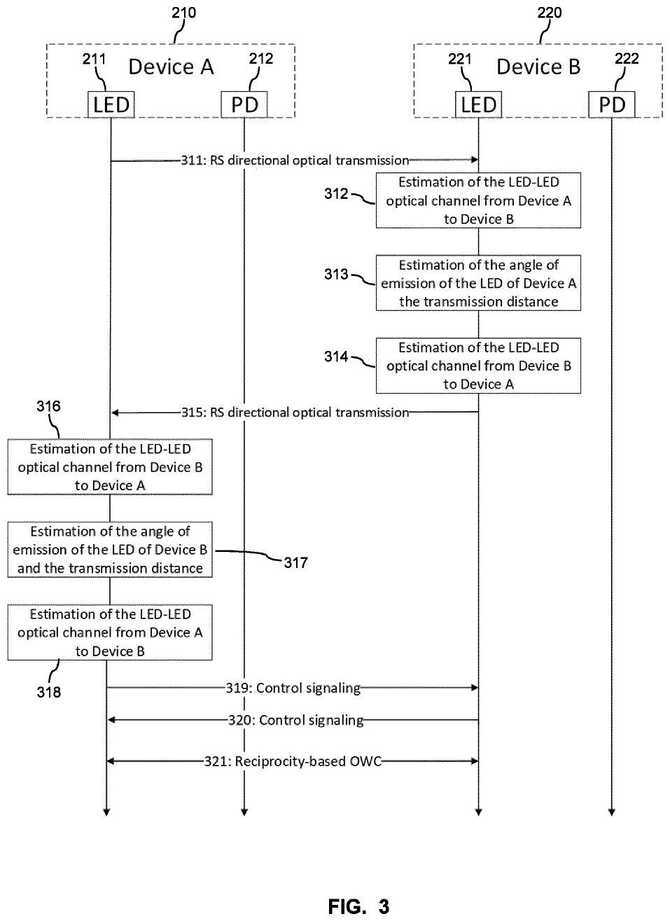

FIG. 3 shows exemplary processes and signaling which may be used to implement the bi-directional reciprocity-based HD OWC on the LED-LED channels between the first wireless communication device 210 and the second wireless communication device 220.

In the processes of FIG. 3, the first wireless communication device 210 uses its LED 211 to transmit an optical reference signal 311 to the second wireless communication device 220. The second wireless communication device 220 uses its LED 221 to receive the optical reference signal 311.

Based on the optical reference signal 311 as received by the LED 221, the second wireless communication device 220 estimates the channel gain of the LED-LED channel from the LED 211 to the LED 221, as indicated by block 312. Based on the estimated channel gain, the second wireless communication device 220 estimates the angle of emission of the LED 211 and the transmission distance of the optical reference signal 311, i.e., the distance from the LED 211 to the LED 221, as indicated by block 313.

Assuming channel reciprocity, the second wireless communication device 220 then estimates the channel gain of the LED-LED channel from the LED 221 to the LED 211 form the channel gain of the reverse channel, the estimated angle of emission, and the estimated transmission distance, as indicated by block 314.

Further, the second wireless communication device 220 uses its LED 221 to transmit an optical reference signal 315 to the first wireless communication device 210. The first wireless communication device 210 uses its LED 211 to receive the optical reference signal 315.

Based on the optical reference signal 315 as received by the LED 211, the first wireless communication device 210 estimates the channel gain of the LED-LED channel from the LED 221 to the LED 211, as indicated by block 316. Based on the estimated channel gain, the first wireless communication device 210 estimates the angle of emission of the LED 221 and the transmission distance of the optical reference signal 315, i.e., the distance from the LED 221 to the LED 211, as indicated by block 317.

Assuming channel reciprocity, the first wireless communication device 210 then estimates the channel gain of the LED-LED channel from the LED 211 to the LED 221 form the channel gain of the reverse channel estimated at block 316, the estimated angle of emission and the estimated transmission distance estimated at block 317, as indicated by block 318.

As further illustrated, the first wireless communication device 210 may then send control signaling 319 to the second wireless communication device 220 and/or the second wireless communication device 210 may send control signaling 320 to the first wireless communication device 210. The control signaling 319, 320 may for example be used to negotiate or otherwise confirm one or more transmission parameters derived from the channel gains estimated at block 314 and 318.

As indicated by 321, the first wireless communication device 210 and the second wireless communication device 220 may then engage in bi-directional OWC, using the LEDs 211 and 221 as both transmitter and receiver. Since the same LED 211, 221 cannot simultaneously operate as a transmitter and a receiver, the bi-directional OWC is performed in HD mode.

As can be seen from the illustration of FIG. 3, the PDs 212 and 222 of the wireless communication devices 210, 220 are not involved in the processes. Accordingly, the PDs 212 and 222 could also be omitted, which may be useful if the wireless communication devices 210, 220 correspond to low-complexity devices with small form factor, e.g., Internet of Things (IoT) devices.

In a modification of the above processes, the angle of emission ϕ_{A} of the transmitting LED 211 and the LED-LED distance d_{AB} can be derived from the form of g(.) and the PDF of w, if corresponding information is available. In particular, assuming that g(.) is known, its inverse, g⁻¹(.) can be derived. Together with the PDF of w, a one-step estimator for the angle of emission ϕ_{A} can be obtained based on relation (8). Such one-step estimator could use the level of the collected optical power of the receiving LED 221 as input, as detected by the electrical output signal y_{electrical}^{B}, and directly output an estimate of the angle of emission ϕ_{A} of the LED 211. Similarly, such one-step estimator could use the level of the collected optical power of the receiving LED 221 as input, as detected by the electrical output signal y_{electrical}^{B}, and directly output an estimate of the angle of the LED-LED distance d_{AB}. Similar modifications may also be made on the side of the first wireless communication device in order to directly estimate the angle of emission of the LED 221 and the LED-LED-distance from the electrical output signal of the LED 211.

In the following, it will be further explained how the illustrated concepts can be utilized to enable utilization of reciprocity-based channel estimation in FD OWC. For this purpose, the PDs 212, 222 may be used as receivers of OWC signals, so that simultaneous transmission of incoming OWC signals and reception of outgoing OWC signals by the wireless communication devices 210, 220 becomes possible. In particular, the FD OWC may be achieved by also using the LED-PD channel from the LED 211 to the PD 222 and the LED-PD channel from the LED 221 to the PD 212. As compared to the previously described HD OWC, the FD OWC may provide a higher spectral efficiency and/or higher data throughput.

As already explained above, since within each wireless communication device 210, 220 the PD 212, 222 is spatially separated from the LED 211, 221, which transmits the outgoing OWC signals, a channel reciprocity assumption does not necessarily apply for the LED-PD channel from the first wireless communication device 210 to the second wireless communication device 220 and the LED-PD channel from the second wireless communication device 220 to the second wireless communication device 210. However, based on estimation of the LED-PD channel and the LED-LED channel from the first wireless communication device 210, the second wireless communication device 220 can judge whether the LED-PD channel and the LED-LED channel are similar and indicate corresponding information to the first wireless communication device 210. Based on this information, the first wireless communication device 210 can then decide whether to apply a channel reciprocity assumption by estimating the LED-PD channel from the first wireless communication device 210 to the second wireless communication device 220 based on the LED-LED channel from the second wireless communication device 220 to the first wireless communication device 210. Similarly, based on estimation of the LED-PD channel and the LED-LED channel from the second wireless communication device 220, the first wireless communication device 210 can judge whether the LED-PD channel and the LED-LED channel are similar and indicate corresponding information to the first wireless communication device 220. Based on this information, the second wireless communication device 220 can then decide whether to apply a channel reciprocity assumption by estimating the LED-PD channel from the second wireless communication device 220 to the first wireless communication device 210 based on the LED-LED channel from the first wireless communication device 210 to the second wireless communication device 220. The information indicated between the two wireless communication devices 210, 220 may be based on a single information bit per transmission direction and may thus be signaled in a resource efficient manner.

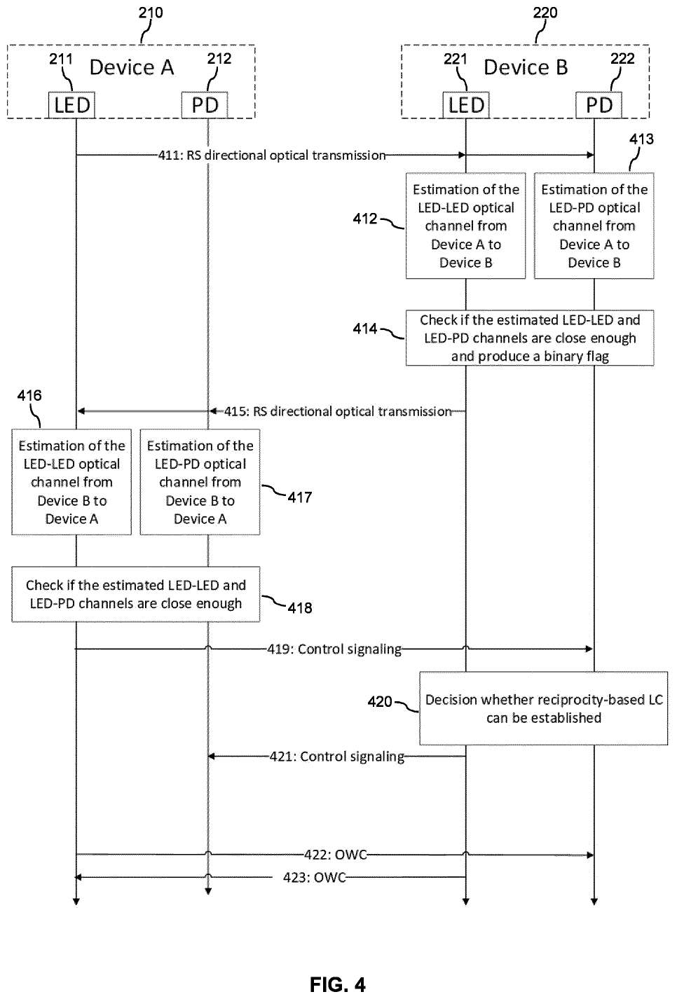

FIG. 4 shows exemplary processes and signaling which may be used to implement the bi-directional reciprocity-based HD OWC on the LED-LED channels between the first wireless communication device 210 and the second wireless communication device 220.

In the processes of FIG. 4, the first wireless communication device 210 uses its LED 211 to transmit an optical reference signal 411 to the second wireless communication device 220. The second wireless communication device 220 uses its LED 221 to receive the optical reference signal 411. Further, the second wireless communication device 220 uses its PD 222 to receive the optical reference signal 411.

Based on the optical reference signal 411 as received by the LED 221, the second wireless communication device 220 estimates the channel gain of the LED-LED channel from the LED 211 to the LED 221, as indicated by block 412. Further, based on the optical reference signal 411 as received by the PD 222, the second wireless communication device 220 estimates the channel gain of the LED-PD channel from the LED 211 to the PD 222, as indicated by block 413. These estimations may performed in a similar manner as explained above. In the case of the LED-LED channel, the estimation may thus be performed based on the electrical output signal of the LED 221 and the known characteristics, e.g., frequency response, of the transmitting LED 211. In the case of the LED-PD channel, the estimation may be performed based on the electrical output signal of the PD 222 and any known method suited to the linear estimation problem of relation (8). As indicated by block 414, the second wireless communication device 220 then checks if the estimated LED-LED-channel and the estimated LED-PD-channel are sufficiently similar, e.g., by comparing the difference of the estimated channel gains to a threshold. Such threshold may be pre-configured in the second wireless communication device 220, e.g., based on operator settings, manufacturer settings, and/or based on configuration information signaled to the second wireless communication device 220. Based on the check of block 414, the second wireless communication device 220 generates control information, which may be in the form of a binary flag, to indicate whether the estimated LED-LED-channel and the estimated LED-PD-channel are sufficiently similar.

The second wireless communication device 220 uses its LED 221 to transmit an optical reference signal 415 to the second wireless communication device 210. The first wireless communication device 210 uses its LED 211 to receive the optical reference signal 415. Further, the first wireless communication device 210 uses its PD 212 to receive the optical reference signal 415.

Based on the optical reference signal 415 as received by the LED 211, the first wireless communication device 210 estimates the channel gain of the LED-LED channel from the LED 221 to the LED 211, as indicated by block 416. Further, based on the optical reference signal 415 as received by the PD 212, the first wireless communication device 210 estimates the channel gain of the LED-PD channel from the LED 221 to the PD 212, as indicated by block 417. These estimations may performed in a similar manner as explained above. In the case of the LED-LED channel, the estimation may thus be performed based on the electrical output signal of the LED 211 and the known characteristics, e.g., frequency response, of the transmitting LED 221. In the case of the LED-PD channel, the estimation may be performed based on the electrical output signal of the PD 212 and any known method suited to the linear estimation problem of relation (8). As indicated by block 418, the first wireless communication device 210 then checks if the estimated LED-LED-channel and the estimated LED-PD-channel are sufficiently similar, e.g., by comparing the difference of the estimated channel gains to a threshold. Such threshold may be pre-configured in the first wireless communication device 210, e.g., based on operator settings, manufacturer settings, and/or based on configuration information signaled to the first wireless communication device 210. Based on the check of block 418, the first wireless communication device 210 generates control information, which may be in the form of a binary flag, to indicate whether the estimated LED-LED-channel and the estimated LED-PD-channel are sufficiently similar. In the example of FIG. 4, the first wireless communication device 210 then sends control signaling 419 indicating the control information determined at block 418 to the second wireless communication device 220.

At block 420, the second wireless communication device 220 then decides based on the control information determined at blocks 414 and 418, whether to base OWC on channel reciprocity. In particular, if the control information indicates that the LED-PD channels between the first wireless communication device 210 and the second wireless communication device 220 are sufficiently similar, the second wireless communication device 220 may decide to apply a channel reciprocity assumption, allowing the first wireless communication device 210 to estimate the LED-PD channel from the first wireless communication device 210 to the second wireless communication device 220 based on the LED-LED channel from the second wireless communication device 220 to the first wireless communication device 210, and allowing the second wireless communication device 220 to estimate the LED-PD channel from the second wireless communication device 220 to the first wireless communication device 210 based on the LED-LED channel from the first wireless communication device 210 to the second wireless communication device 220. The second wireless communication device 220 then indicates the result of this decision by control signaling 421 to the first wireless communication device 210.

As indicated by 422 and 423, the first wireless communication device 210 and the second wireless communication device 220 may then engage in bi-directional OWC, using the LEDs 211, 221 as transmitter and simultaneously using the PDs 212, 222 as receiver. Accordingly, the bi-directional OWC may be performed in FD mode. If at block 420 the second wireless communication device 220 decided to apply the channel reciprocity assumption, the transmitted OWC signals 422, 423 are controlled based on the estimation of the LED-LED channel performed by the respective transmitting wireless communication device 210, 220. Otherwise, the transmitted OWC signals can for example be controlled without any optimization based on a channel estimate, e.g., based on a worst-case assumption of channel conditions, or controlled based on channel estimation feedback from the respective receiving wireless communication device 210, 220.

It is noted that, based on the control information produced at blocks 414 and 418, the reciprocity assumption could also be applied to only one transmission direction. That is to say, if the control information indicates that the LED-PD channel from the first wireless communication device 210 to the second wireless communication device 220 is sufficiently similar to the LED-LED channel from the first wireless communication device 210 to the second wireless communication device 220, the second wireless communication device 220 may decide to apply a channel reciprocity assumption only at the second wireless communication device 220, allowing the second wireless communication device 220 to estimate the LED-PD channel from the second wireless communication device 220 to the first wireless communication device 210 based on the LED-LED channel from the first wireless communication device 210 to the second wireless communication device 220. Similarly, if the control information indicates that the LED-PD channel from the second wireless communication device 220 to the first wireless communication device 210 is sufficiently similar to the LED-LED channel from the second wireless communication device 220 to the first wireless communication device 210, the second wireless communication device 220 may decide to apply a channel reciprocity assumption only at the first wireless communication device 210, allowing the first wireless communication device 210 to estimate the LED-PD channel from the first wireless communication device 210 to the second wireless communication device 220 based on the LED-LED channel from the second wireless communication device 220 to the first wireless communication device 210.

Accordingly, in the processes of FIG. 4, FD OWC can be always established. However, the application of channel reciprocity in one or both transmission directions is conditional and depends on the estimated similarity of the LED-PD channel and LED-LED channel.

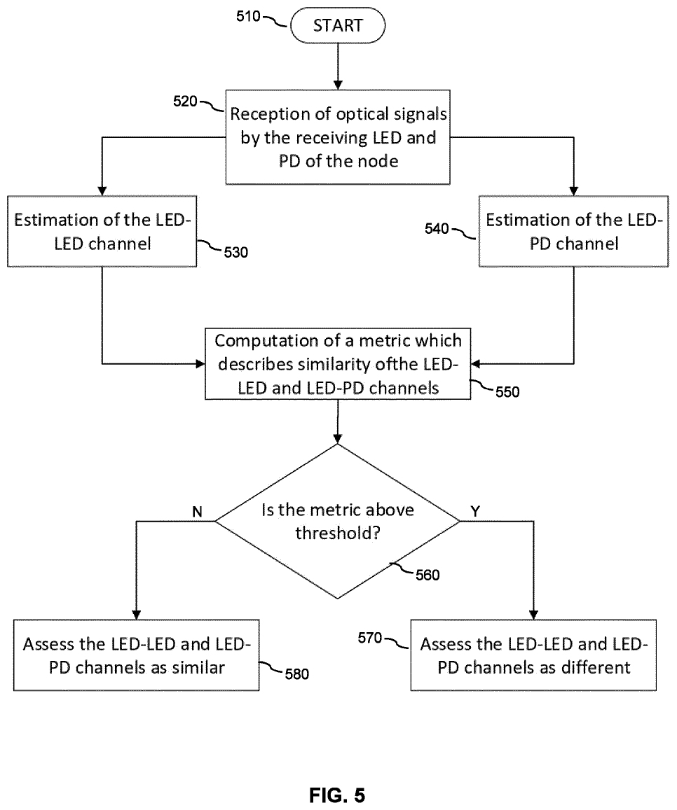

FIG. 5 shows a decision diagram for further illustrating a channel-estimation procedure as used in the processes of FIG. 4. The procedure of FIG. 5 may be implemented by a wireless communication device which receives OWC signals from another wireless communication device, such as the first wireless communication device 210 to the second wireless communication device 220.

The procedure starts at 510. Then, at 520, using an LED and a PD of the node as received, the considered node receives optical signals from an LED of another node. As explained above, these optical signals may be reference signals, i.e., have known characteristics. For example, at 520 the first wireless communication device 210 could receive an optical reference signal using the LED 211 and the PD 212 as receiver, or the second wireless communication device 220 could receive an optical reference signal using the LED 221 and the PD 222 as receiver.

At 530, the node estimates the LED-LED channel based on the optical signals as received by the LED. At 540, the node estimates the LED-PD channel based on the optical signals as received by the PD.

At 550, the node computes a metric describing the similarity of the LED-LED channel and the LED-PD channel. For example, such metric could be based on the normalized difference in channel gain between the LED-LED channel and the LED-PD channel. In that case, a high value of the difference would indicate low similarity, and a low value of the difference would indicate high similarity.

At 560, the metric is compared to the threshold. In the illustrated example, it is assumed that a high value of the difference indicates low similarity, and a low value of the difference indicates high similarity. Accordingly, if the metric is above the threshold, the node assesses the LED-LED channel and the LED-PD channel as being different, as indicated by branch “Y” and 570. Otherwise, as indicated by branch “Y” and 580, the node assesses the LED-LED channel and the LED-PD channel as being similar.

As can be seen, the procedure of FIG. 5 may be used in the processes of FIG. 4 to derive the control information of block 414 or block 418.

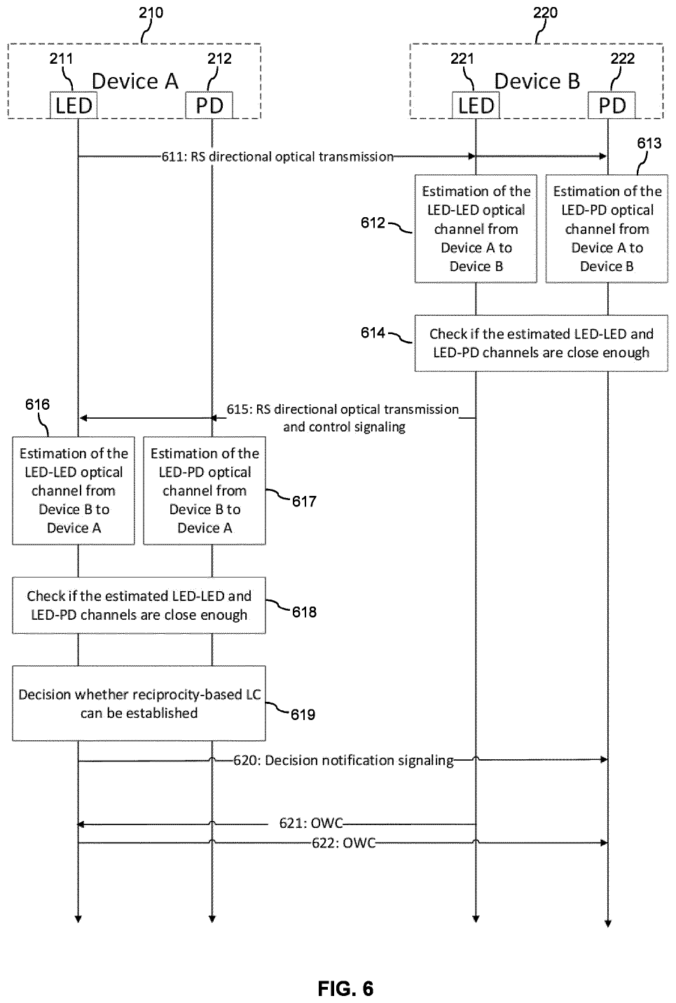

FIG. 6 shows further exemplary processes and signaling which may be used to implement the bi-directional reciprocity-based HD OWC on the LED-LED channels between the first wireless communication device 210 and the second wireless communication device 220.

In the processes of FIG. 6, the first wireless communication device 210 uses its LED 211 to transmit an optical reference signal 611 to the second wireless communication device 220. The second wireless communication device 220 uses its LED 221 to receive the optical reference signal 611. Further, the second wireless communication device 220 uses its PD 222 to receive the optical reference signal 611.

Based on the optical reference signal 611 as received by the LED 221, the second wireless communication device 220 estimates the channel gain of the LED-LED channel from the LED 211 to the LED 221, as indicated by block 612. Further, based on the optical reference signal 611 as received by the PD 222, the second wireless communication device 220 estimates the channel gain of the LED-PD channel from the LED 211 to the PD 222, as indicated by block 613. These estimations may performed in a similar manner as explained above. In the case of the LED-LED channel, the estimation may thus be performed based on the electrical output signal of the LED 221 and the known characteristics, e.g., frequency response, of the transmitting LED 211. In the case of the LED-PD channel, the estimation may be performed based on the electrical output signal of the PD 222 and any known method suited to the linear estimation problem of relation (8). As indicated by block 614, the second wireless communication device 220 then checks if the estimated LED-LED-channel and the estimated LED-PD-channel are sufficiently similar, e.g., by comparing the difference of the estimated channel gains to a threshold. Such threshold may be pre-configured in the second wireless communication device 220, e.g., based on operator settings, manufacturer settings, and/or based on configuration information signaled to the second wireless communication device 220. Based on the check of block 614, the second wireless communication device 220 generates control information, which may be in the form of a binary flag, to indicate whether the estimated LED-LED-channel and the estimated LED-PD-channel are sufficiently similar.

The second wireless communication device 220 uses its LED 221 to transmit an optical reference signal 615 to the second wireless communication device 210. In the example of FIG. 6, the optical reference signal 615 further indicates the control information generated at block 614. The first wireless communication device 210 uses its LED 211 to receive the optical reference signal 615. Further, the first wireless communication device 210 uses its PD 212 to receive the optical reference signal 615.

Based on the optical reference signal 615 as received by the LED 211, the first wireless communication device 210 estimates the channel gain of the LED-LED channel from the LED 221 to the LED 211, as indicated by block 616. Further, based on the optical reference signal 415 as received by the PD 212, the first wireless communication device 210 estimates the channel gain of the LED-PD channel from the LED 221 to the PD 212, as indicated by block 617. These estimations may performed in a similar manner as explained above. In the case of the LED-LED channel, the estimation may thus be performed based on the electrical output signal of the LED 211 and the known characteristics, e.g., frequency response, of the transmitting LED 221. In the case of the LED-PD channel, the estimation may be performed based on the electrical output signal of the PD 212 and any known method suited to the linear estimation problem of relation (8). As indicated by block 618, the first wireless communication device 210 then checks if the estimated LED-LED-channel and the estimated LED-PD-channel are sufficiently similar, e.g., by comparing the difference of the estimated channel gains to a threshold. Such threshold may be pre-configured in the first wireless communication device 210, e.g., based on operator settings, manufacturer settings, and/or based on configuration information signaled to the first wireless communication device 210. Based on the check of block 618, the first wireless communication device 210 generates control information, which may be in the form of a binary flag, to indicate whether the estimated LED-LED-channel and the estimated LED-PD-channel are sufficiently similar.

At block 619, the first wireless communication device 210 then decides based on the control information determined at blocks 614 and 618, whether to base OWC on channel reciprocity. In particular, if the control information indicates that the LED-PD channels between the first wireless communication device 210 and the second wireless communication device 220 are sufficiently similar, the first wireless communication device 210 may decide to apply a channel reciprocity assumption, allowing the first wireless communication device 210 to estimate the LED-PD channel from the first wireless communication device 210 to the second wireless communication device 220 based on the LED-LED channel from the second wireless communication device 220 to the first wireless communication device 210, and allowing the second wireless communication device 220 to estimate the LED-PD channel from the second wireless communication device 220 to the first wireless communication device 210 based on the LED-LED channel from the first wireless communication device 210 to the second wireless communication device 220. The first wireless communication device 210 then indicates the result of this decision by decision notification signaling 621 to the second wireless communication device 220.

As indicated by 621 and 622, the first wireless communication device 210 and the second wireless communication device 220 may then engage in bi-directional OWC, using the LEDs 211, 221 as transmitter and simultaneously using the PDs 212, 222 as receiver. Accordingly, the bi-directional OWC may be performed in FD mode. If at block 619 the first wireless communication device 210 decided to apply the channel reciprocity assumption, the transmitted OWC signals 621, 622 are controlled based on the estimation of the LED-LED channel performed by the respective transmitting wireless communication device 210, 220. Otherwise, the transmitted OWC signals can for example be controlled without any optimization based on a channel estimate, e.g., based on a worst-case assumption of channel conditions, or controlled based on channel estimation feedback from the respective receiving wireless communication device 210, 220.

As compared to the processes of FIG. 4, the processes of FIG. 6 utilize the optical reference signal to also indicate the assessed similarity of the LED-LED channel and the LED-PD channel. Such combined transmission can be done either by supplementing the optical reference signal with a control signaling portion which encodes the control signaling or by using the optical reference signal itself to encode the control information. For example, the optical reference signal could be based on selecting between two pre-defined signal sequences, each corresponding to a different state of the binary flag of the control information and further being usable for estimating the channel gain using relation (8).

It is noted that, based on the control information produced at blocks 614 and 618, the reciprocity assumption could also be applied to only one transmission direction. That is to say, if the control information indicates that the LED-PD channel from the first wireless communication device 210 to the second wireless communication device 220 is sufficiently similar to the LED-LED channel from the first wireless communication device 210 to the second wireless communication device 220, the second wireless communication device 220 may decide to apply a channel reciprocity assumption only at the second wireless communication device 220, allowing the second wireless communication device 220 to estimate the LED-PD channel from the second wireless communication device 220 to the first wireless communication device 210 based on the LED-LED channel from the first wireless communication device 210 to the second wireless communication device 220. Similarly, if the control information indicates that the LED-PD channel from the second wireless communication device 220 to the first wireless communication device 210 is sufficiently similar to the LED-LED channel from the second wireless communication device 220 to the first wireless communication device 210, the second wireless communication device 220 may decide to apply a channel reciprocity assumption only at the first wireless communication device 210, allowing the first wireless communication device 210 to estimate the LED-PD channel from the first wireless communication device 210 to the second wireless communication device 220 based on the LED-LED channel from the second wireless communication device 220 to the first wireless communication device 210.

Accordingly, in the processes of FIG. 6, FD OWC can be always established. However, the application of channel reciprocity in one or both transmission directions is conditional and depends on the estimated similarity of the LED-PD channel and LED-LED channel.

It is further noted that in the processes of FIGS. 4 and 6 the FD OWC can take place either using a different frequency for each of the two transmission directions, or, using the same frequency in both transmission directions. In the latter case, it may be required that the spatial placement of the LED 211, 221 and the PD 212, 222 in the respective wireless communication device 210, 220 and their optical characteristics prevent or at least sufficiently suppress self-interference. In practice, this can be achieved by placing the PD in such a way that the transmitted optical signal from the LED does not reach the field-of vision of the PD.

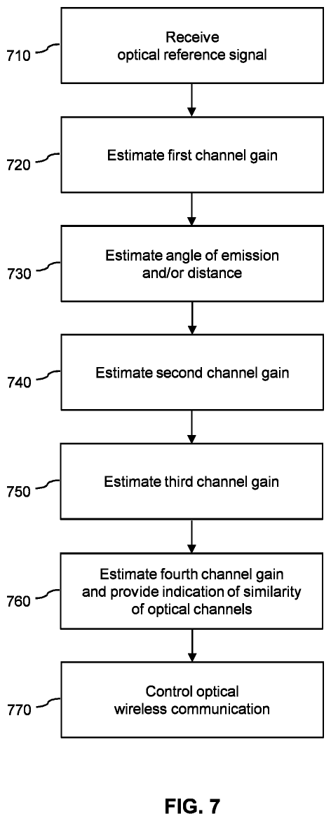

FIG. 7 shows a flowchart for illustrating a method, which may be utilized for implementing the illustrated concepts. The method of FIG. 7 may be used for implementing the illustrated concepts in a wireless communication device, such as the above-mentioned access node 100 or one of the above-mentioned MSs 11.

If a processor-based implementation of the wireless communication device is used, at least some of the steps of the method of FIG. 7 may be performed and/or controlled by one or more processors of the wireless device. Such wireless device may also include a memory storing program code for implementing at least some of the below described functionalities or steps of the method of FIG. 7.

At step 710, the wireless communication device receives an optical reference signal from an LED of a further wireless communication device. This accomplished using an LED of the wireless communication device as a receiver. The above-mentioned optical reference signals 411, 415, 611, and 615 are examples of the optical reference signal received at step 710. In some scenarios, the wireless communication device may further receive the optical reference signal using a photodetector of the wireless communication device as a receiver; e.g., as explained in the examples of FIGS. 4, 5, and 6.

At step 720, the wireless communication device estimates a first channel gain of an optical channel from the LED of the further wireless communication device to the LED of the wireless communication device. The estimation of step 720 is performed based on the optical reference signal as received by the LED at step 710. Further, estimation of step 720 may be based on a characteristic of the LED of the further wireless communication device, e.g., a known frequency response of the LED.

At step 730, the wireless communication device may further estimate an angle of emission of the optical channel from the LED of the further wireless communication device to the LED of the wireless communication device and/or a distance from the LED of the further wireless communication device to the LED of the wireless communication device. The estimation of step 720 may be based on the first channel gain estimated at step 720. Alternatively, the estimation of step 720 could be performed directly based on the optical reference signal as received by the LED at step 710.

At step 740, the wireless communication device estimates a second channel gain of an optical channel from the LED of the wireless communication device to the LED of the further wireless communication device. The estimation of step 740 is be performed based on the first channel gain estimated at step 720. Further, the estimation of step 740 may be based on the angle of emission and/or distance estimated at step 730.

At step 750, the wireless communication device may estimate a third channel gain of an optical channel from the LED of the wireless communication device to a photodetector of the further wireless communication device. The estimation of step 750 may be based on the first channel gain estimated at step 720.

The estimation of step 750 may involve that the wireless communication device receives, from the further wireless communication device, a first indication that an optical channel from the LED of the wireless communication device to the LED of the further wireless communication device is similar to an optical channel from the LED of the wireless communication device to a photodetector of the further wireless communication device, e.g., as explained for the control information signaled in the examples of FIGS. 4 and 6. 12. The first indication may be conveyed by the optical reference signal received from the further wireless communication device, e.g., as explained for the optical reference signal 615 in the example of FIG. 6. The first indication may be based on an optical reference signal transmitted from the LED of the wireless communication device.

As step 760, based on the optical reference signal as received by the photodetector of the wireless communication device, the wireless communication device may estimate a fourth channel gain of an optical channel from the LED of the further wireless communication device to the photodetector of the wireless communication device. Based on a comparison of the fourth channel gain to the first channel gain, the wireless communication device may then send, to the further wireless communication device, a second indication that an optical channel from the LED of the further wireless communication device to the LED of the wireless communication device is similar to an optical channel from the LED of the further wireless communication device to the photodetector of the wireless communication device. The second indication is based on the optical reference signal received from the further wireless communication device. The second indication may be conveyed by an optical reference signal transmitted from the LED of the wireless communication device, e.g., as explained for the optical reference signal 615 in the example of FIG. 6.

At step 770, the wireless communication device controls transmission of outgoing optical wireless communication signals from the wireless communication device to the further wireless communication device. This controlling of transmission is based on the second channel gain estimated at step 740. Further, the controlling of transmission at step 770 may be based on the third channel gain estimated at step 750 and/or the fourth channel gain and indication of similarity from step 760. In some scenarios, the controlling of transmission at step 770 may be based on the third channel gain estimated at step 750 and/or on the first indication received at step 750.

In some scenarios, step 770 may involve that based on the first indication of step 750 and the second indication of step 760, the wireless communication device controls FD optical communication between the wireless communication device and the further wireless communication device. In particular, the wireless communication device may decide based on the first indication and/or the second indication whether to apply reciprocity-based channel estimation to the FD optical communication. For example, the wireless communication device may decide that reciprocity-based channel estimation shall be applied to incoming OWC signals, to outgoing OWC signals, or to both incoming and outgoing OWC signals.

The FD optical communication may involve that, using the LED of the wireless communication device as a transmitter, the wireless device sends outgoing OWC signals to be received by the PD of the further wireless communication device while simultaneously, using the PD of the wireless communication device as a receiver, the wireless communication device receives incoming OWC signals from the further wireless communication device.

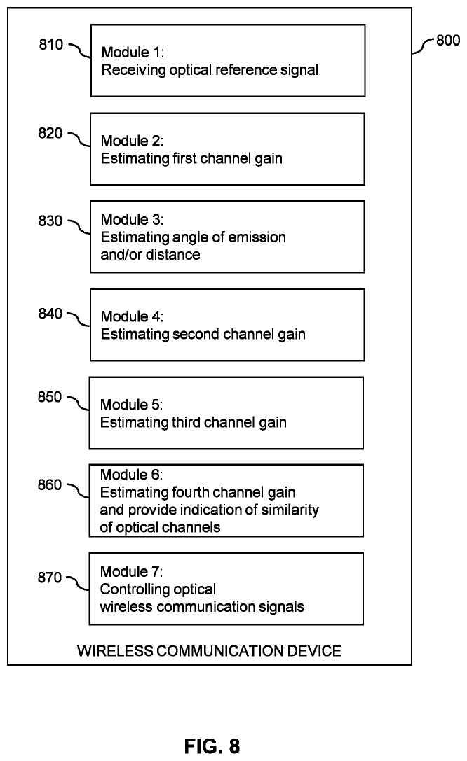

FIG. 8 shows a block diagram for illustrating functionalities of a wireless communication device 800 which operates according to the method of FIG. 7. The wireless communication device 800 may for example correspond to the above-mentioned access node 100 or one of the above-mentioned MSs 11. As illustrated, the wireless communication device 800 may be provided with a module 810 configured to receive an optical reference signal, such as explained in connection with step 710. Further, the wireless communication device 800 may be provided with a module 820 configured to estimate a first channel gain, such as explained in connection with step 720. Further, the wireless communication device 800 may be provided with a module 830 configured to estimate an angle of emission and/or distance, such as explained in connection with step 730. Further, the wireless communication device 800 may be provided with a module 840 configured to estimate a second channel gain, such as explained in connection with step 740. Further, the wireless communication device 800 may be provided with a module 850 configured to estimate a third channel gain, such as explained in connection with step 750. Further, the wireless communication device 800 may be provided with a module 860 configured to estimate a fourth channel gain and provide an indication of similarity of optical channels, such as explained in connection with step 760. Further, the wireless communication device 800 may be provided with a module 870 configured to control OWC signals, such as explained in connection with step 770.

It is noted that the wireless communication device 800 may include further modules for implementing other functionalities, such as known functionalities of a mobile station or of an access node of a wireless communication network. Further, it is noted that the modules of the wireless communication device 800 do not necessarily represent a hardware structure of the wireless communication device 800, but may also correspond to functional elements, e.g., implemented by hardware, software, or a combination thereof.

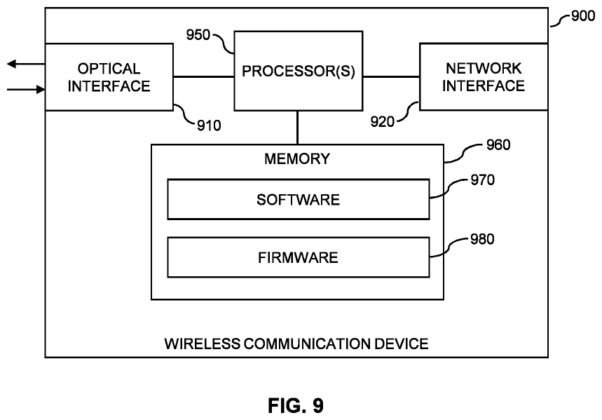

FIG. 9 illustrates a processor-based implementation of a wireless communication device 900. The structures as illustrated in FIG. 9 may be used for implementing the above-described concepts. The wireless communication device 900 may for example correspond to one of above-mentioned mentioned MSs 11 or to the above-mentioned access node 100.

As illustrated, the wireless communication device 900 includes an optical interface 910. The optical interface may for example be based on an LC technology, e.g., operating in the visible and/or infrared spectrum. Further, if the wireless communication device 900 corresponds to an access node, such as the above-mentioned access node 100, the wireless communication device 900 may also include a network interface 920, which may be used for communication with other nodes of the wireless communication network.

Further, the wireless communication device 900 includes one or more processors 950 coupled to the interface(s) 910, 920 and a memory 960 coupled to the processor(s) 950. By way of example, the interface(s) 910, 920, the processor(s) 950, and the memory 960 could be coupled by one or more internal bus systems of the wireless communication device 900. The memory 960 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 860 may include software 970 and/or firmware 980. The memory 960 may include suitably configured program code to be executed by the processor(s) 950 so as to implement the above-described functionalities for controlling wireless transmissions, such as explained in connection with FIG. 7.

It is to be understood that the structures as illustrated in FIG. 9 are merely schematic and that the wireless communication device 900 may actually include further components which, for the sake of clarity, have not been illustrated, e.g., further interfaces or further processors. Also, it is to be understood that the memory 960 may include further program code for implementing known functionalities of a mobile station or access node. According to some embodiments, also a computer program may be provided for implementing functionalities of the wireless communication device 900, e.g., in the form of a physical medium storing the program code and/or other data to be stored in the memory 8960 or by making the program code available for download or by streaming.

As can be seen, the concepts as described above may be used for efficiently controlling OWC. By using an LED as a receiver of an optical reference signal, channel gain of the LED-LED channel can be estimated and used as a basis for reciprocity-based channel estimation. Further, the estimated channel gain can be used to assess similarity of the LED-LED channel and an LED-PD channel. In this way, reciprocity-based channel estimation can be conditionally applied to the LED-PD channel.

It is to be understood that the examples and embodiments as explained above are merely illustrative and susceptible to various modifications. For example, the illustrated concepts may be applied in connection with various kinds of OWC technologies. Further, the concepts may be applied with respect to various types of wireless communication devices. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1-21. (canceled)

22. A method of controlling optical wireless communication, the method comprising:
using a light emitting diode (LED) of a first wireless communication device as a receiver, the first wireless communication device receiving an optical reference signal from an LED of a second wireless communication device;
based on the optical reference signal as received by the LED, the first wireless communication device estimating a first channel gain of an optical channel from the LED of the second wireless communication device to the LED of the first wireless communication device;
based on the estimated first channel gain, the first wireless communication device estimating a second channel gain of an optical channel from the LED of the first wireless communication device to the LED of the second wireless communication device; and
based on the estimated second channel gain, the first wireless communication device controlling transmission of outgoing optical wireless communication signals from the first wireless communication device to the second wireless communication device.

23. The method according to claim 22, wherein the estimating the first channel gain is further based on a characteristic of the LED of the further wireless communication device.

24. The method according to claim 22, further comprising:
based on the estimated first channel gain, the first wireless communication device estimating an angle of emission of the optical channel from the LED of the second wireless communication device to the LED of the first wireless communication device; and
wherein the estimating of the second channel gain is further based on the estimated angle of emission.

25. The method according to claim 22, further comprising:
based on the estimated first channel gain, the first wireless communication device estimating a distance from the LED of the second wireless communication device to the LED of the first wireless communication device; and
wherein the estimating of the second channel gain is further based on the estimated distance.

26. The method according to claim 22, further comprising:
based on the first channel gain, the first wireless communication device estimating a third channel gain of an optical channel from the LED of the first wireless communication device to a photodetector of the second wireless communication device; and
based on the estimated third channel gain, the first wireless communication device controlling transmission of outgoing optical wireless communication signals from the first wireless communication device to the second wireless communication device.

27. The method according to claim 26, further comprising:
the first wireless communication device receiving, from the second wireless communication device, a first indication that an optical channel from the LED of the first wireless communication device to the LED of the second wireless communication device is similar to an optical channel from the LED of the first wireless communication device to a photodetector of the second wireless communication device; and
based on the first indication and estimated third channel gain, the first wireless communication device controlling transmission of optical wireless communication signals from the first wireless communication device to the second wireless communication device.

28. The method according to claim 22, further comprising:
the first wireless communication device further receiving the optical reference signal using a photodetector of the first wireless communication device as a receiver;
based on the optical reference signal as received by the photodetector of the first wireless communication device, the first wireless communication device estimating a fourth channel gain of an optical channel from the LED of the second wireless communication device to the photodetector of the first wireless communication device; and
based on a comparison of the fourth channel gain to the first channel gain, the first wireless communication device sending, to the second wireless communication device, a second indication that an optical channel from the LED of the second wireless communication device to the LED of the first wireless communication device is similar to an optical channel from the LED of the second wireless communication device to the photodetector of the first wireless communication device.

29. The method according to claim 27, further comprising, based on the first indication and the second indication, the first wireless communication device controlling full-duplex optical communication between the first wireless communication device and the second wireless communication device.

30. The method according to claim 29, wherein the full-duplex optical communication comprises:
using the LED of the first wireless communication device as a transmitter, the first wireless communication device sending outgoing optical wireless communication signals to be received by the photodetector of the second wireless communication device; and
simultaneously using the photodetector of the first wireless communication device as a receiver, the first wireless communication device receiving incoming optical wireless communication signals from the second wireless communication device.

31. The method according to claim 28, wherein the second indication is based on the optical reference signal received from the second wireless communication device.

32. The method according to claim 28, wherein the second indication is conveyed by an optical reference signal transmitted from the LED of the first wireless communication device.

33. The method according to claim 27, wherein the first indication is conveyed by the optical reference signal received from the second wireless communication device.

34. The method according to claim 27, wherein the first indication is based on an optical reference signal transmitted from the LED of the first wireless communication device.

35. The method according to claim 22, wherein the first wireless communication device is a mobile station.

36. The method according to claim 22, wherein the second wireless communication device is an access node of a wireless communication network.

37. The method according to claim 22, wherein the first wireless communication device is an access node of a wireless communication network.

38. The method according to claim 22, wherein the second wireless communication device is a mobile station.

39. A wireless communication device comprising:
at least one processing circuit; and
a memory comprising program code executable by the at least one processing circuit, whereby execution of the program code by the at least one processing circuit causes the wireless communication device to:
using a light emitting diode (LED) of the wireless communication device as a receiver, receive an optical reference signal from an LED of a further wireless communication device; and
based on the optical reference signal as received by the LED, estimate a first channel gain of an optical channel from the LED of the further wireless communication device to the LED of the wireless communication device;
based on the estimated first channel gain, estimate a second channel gain of an optical channel from the LED of the wireless communication device to the LED of the further wireless communication device; and
based on the estimated second channel gain, control transmission of outgoing optical wireless communication signals from the wireless communication device to the further wireless communication device.
